(19) United States
(12) Patent Application Publication
(10) Pub. No.: US 2021/0116919 A1
(43) Pub. Date: Apr. 22, 2021

(54) AUTONOMOUSLY TRAVELING VEHICLE AND AUTONOMOUSLY TRAVELING DEVICE

(71) Applicant: HONDA MOTOR CO., LTD., Tokyo (JP)

(72) Inventors: Toru Kawai, Wako-shi, Saitama (JP); Takamasa Udagawa, Wako-shi, Saitama (JP); Hiroki Mukai, Wako-shi, Saitama (JP); Hiroto Takahashi, Wako-shi, Saitama (JP); Keiji Muro, Wako-shi, Saitama (JP)

(21) Appl. No.: 17/041,547

(22) PCT Filed: Mar. 30, 2018
(86) PCT No.: PCT/JP2018/013913

§ 371 Date: Sep. 25, 2020

(51) Int. Cl. G05D 1/00; G05D 1/02; G01S 17/931; G01C 19/00; G06K 9/00

(52) U.S. Cl. CPC G05D 1/0088; G05D 1/0238; G05D 1/0214; G06K 9/00335; G01S 17/931; G01C 19/00; G06K 9/00805; G05D 1/0223

(57) ABSTRACT

An autonomously traveling device and/or vehicle capable of autonomously traveling in front of a person and enhancing crime prevention and reliability. The autonomously traveling device includes a distance sensor and a camera (person detection sensor) that detect at least a behavior of the person and a distance from the person, and a control unit that controls the autonomously traveling device based on detected information from the distance sensor and the camera.

### TECHNICAL FIELD

The present invention relates to an autonomously traveling vehicle and an autonomously traveling device distance, and more particularly, to an autonomously traveling vehicle and an autonomously traveling device distance that autonomously travel in front of an operator.

### BACKGROUND ART

Heretofore, for example, in order to reduce burden of a person, a robot for conveyance on which an object to be conveyed, such as baggage or a cargo, is placed to convey the object from a predetermined location to a destination place has been put to practical use. To operate the robot for conveyance, a sensor for detecting an obstacle in front of a movement direction of the robot and causing the robot to travel while avoiding the obstacle so as not to collide with the obstacle is mounted on the robot.

As an autonomously traveling vehicle of related art, for example, a technique in which an operation portion is installed in a hand pushed portion of a handle portion, operation information is displayed on the operation portion by a CPU, and a person causes the vehicle to travel to convey baggage to a predetermined position, without using any force for operating the operation portion is disclosed (e.g., see Patent Literature 1).

Patent Literature 1 described above also discloses a technique for causing an extension unit of the autonomously traveling vehicle to autonomously travel through a predetermined path that is set in advance.

### CITATION LIST

### Patent Literature

Patent Literature 1: WO 2017/030205

### SUMMARY OF INVENTION

### Technical Problem

However, in the related art, there is a need for the person to perform an operation using the operation portion in the case of causing the autonomously traveling vehicle to travel.

Further, when the extension unit is caused to autonomously travel, the extension unit is caused to autonomously travel from behind the person. Accordingly, there is a security problem that baggage placed on the extension unit can be stolen. In addition, there is another problem that, if the person does not check the back side of the extension unit, for example, it is not known whether the extension unit is appropriately following the person, the reliability deteriorates.

The present invention has been made in view of the above-described circumstances, and an object of the present invention is to provide an autonomously traveling vehicle and an autonomously traveling device which are capable of autonomously traveling in front of a person and enhancing crime prevention and reliability.

### Solution to Problem

To achieve the above-described object, an autonomously traveling vehicle according to an aspect of the present invention includes an autonomously traveling device that travels in front of a person. The autonomously traveling device includes a person detection sensor that detects at least a behavior of a person and a distance from a person, and a control unit that controls the autonomously traveling device based on detected information from the person detection sensor.

According to this aspect of the present invention, the autonomously traveling vehicle can autonomously travel in front of a person. Accordingly, baggage placed on the autonomously traveling vehicle can be constantly monitored, which leads to an enhancement of crime prevention. Further, since the person monitors the autonomously traveling vehicle, a stopped state or the like of the autonomously traveling vehicle can be easily checked, which leads to an enhancement of reliability.

In the configuration described above, the person detection sensor detects the behavior of the person, and the control unit controls the autonomously traveling device to turn in a direction in which the person detected by the person detection sensor faces.

According to this aspect of the present invention, the control unit controls the autonomously traveling device to turn in the direction in which the person detected by a camera faces, thereby enabling the autonomously traveling vehicle to automatically turn depending on the behavior of the person.

In the configuration described above, the autonomously traveling device includes a gyroscope sensor and the gyroscope sensor detects a vibration applied to the autonomously traveling device by the person, and in a case where a vibration is detected by the gyroscope sensor, the control unit controls the autonomously traveling device to be started.

According to this aspect of the present invention, when a vibration is detected by the gyroscope sensor, the control unit controls the autonomously traveling device to be started, thereby making it possible to easily start the autonomously traveling vehicle only by the operation in which the person applies a vibration.

In the configuration described above, in a case where the control unit determines that the distance from the person detected by the person detection sensor is more than or equal to a predetermined distance, the control unit controls the autonomously traveling device to travel at a lower speed, or to stop.

According to this aspect of the present invention, when it is determined that the distance from the person detected by a distance sensor is more than or equal to the predetermined distance, the autonomously traveling device is controlled to travel at a lower speed, or to stop, thereby enabling the autonomously traveling vehicle to autonomously travel in front of the person, while preventing the autonomously traveling vehicle from being apart from the person.

In the configuration described above, the autonomously traveling device includes an objective sensor, and in a case where an obstacle is detected in front of the autonomously traveling device by the objective sensor, the control unit controls the autonomously traveling device to avoid the obstacle or to stop.

According to this aspect of the present invention, when the objective sensor detects an obstacle in front of the autonomously traveling device, the control unit controls the autonomously traveling device to avoid the obstacle, or to stop, thereby preventing the autonomously traveling vehicle from colliding with the obstacle.

Further, an autonomously traveling device according to another aspect of the present invention is an autonomously traveling device to be attached to an autonomously traveling vehicle, the autonomously traveling device including a drive wheel for traveling in front of a person, a person detection sensor that detects at least a behavior of a person and a distance from a person, and a control unit that controls driving of the drive wheel based on detected information from the person detection sensor.

According to this aspect of the present invention, the autonomously traveling vehicle can autonomously travel in front of a person. Therefore, baggage placed on the autonomously traveling vehicle can be constantly monitored, which leads to an enhancement of crime prevention. Further, since the autonomously traveling vehicle is monitored by the person, a stopped state or the like of the autonomously traveling vehicle can be easily checked, which leads to an enhancement of reliability.

### Advantageous Effects of Invention

According to the aspects of the present invention, it is possible to cause an autonomously traveling vehicle to autonomously travel in front of a person.

Accordingly, baggage placed on the autonomously traveling vehicle can be constantly monitored, which leads to an enhancement of crime prevention. Further, since the autonomously traveling vehicle is monitored by the person, a stopped state or the like of the autonomously traveling vehicle can be easily checked, which leads to an enhancement of reliability.

### BRIEF DESCRIPTION OF DRAWINGS

FIG. 1 is a schematic view illustrating an autonomously traveling vehicle according to an embodiment of the present invention.

FIG. 2 is a schematic view illustrating the autonomously traveling device according to the present embodiment.

FIG. 3 is a perspective view illustrating the autonomously traveling device according to the present embodiment.

FIG. 4 is an explanatory view illustrating an example of a state where an image of a person is captured by a camera according to the present embodiment.

FIG. 5 is a block diagram illustrating a control configuration according to the present embodiment.

FIG. 6 is a schematic view illustrating a standby state of the autonomously traveling vehicle according to the present embodiment.

FIG. 7 is a schematic view illustrating a traveling start state of the autonomously traveling vehicle according to the present embodiment.

FIG. 8 is a schematic view illustrating an autonomously traveling state of the autonomously traveling vehicle according to the present embodiment.

FIG. 9 is a schematic view illustrating a state where an obstacle is present in front of the autonomously traveling vehicle according to the present embodiment.

FIG. 10 is a schematic view illustrating a state where the autonomously traveling vehicle according to the present embodiment is stopped.

FIG. 11 is a flowchart illustrating an operation according to the present embodiment.

### DESCRIPTION OF EMBODIMENTS

An embodiment of the present invention will be described below with reference to the drawings.

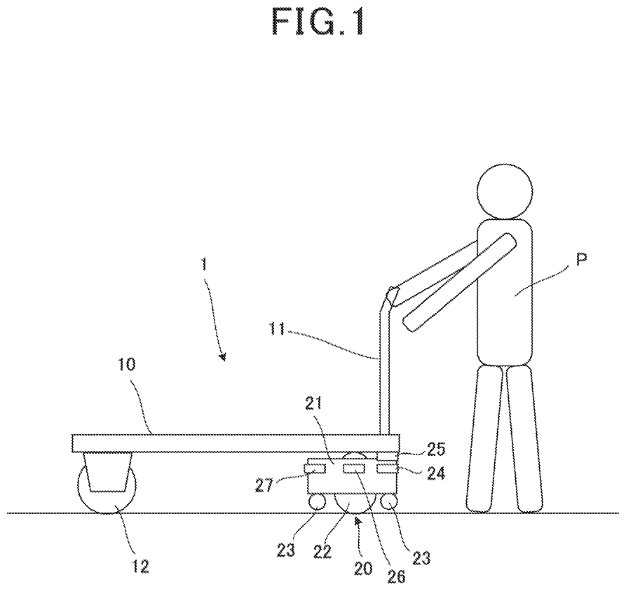

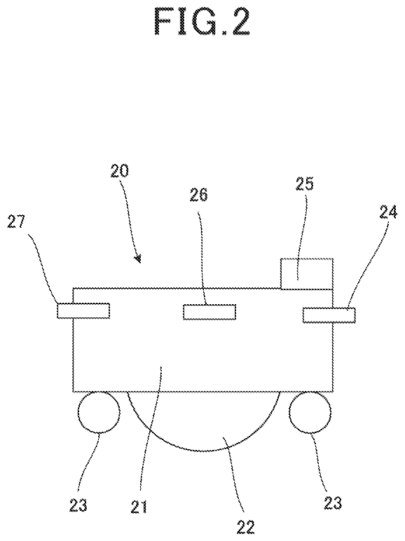

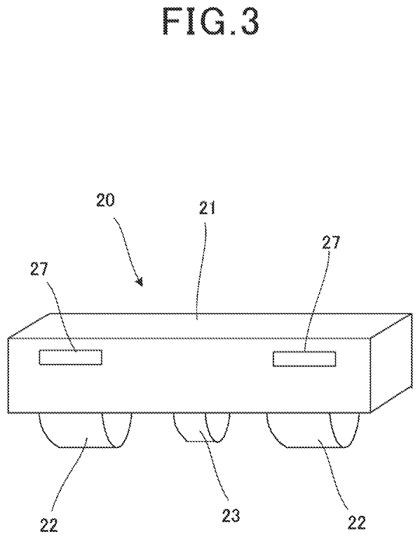

FIG. 1 is a schematic view illustrating an autonomously traveling vehicle according to an embodiment of the present invention. FIG. 2 is a schematic view illustrating an autonomously traveling device according to the present embodiment. FIG. 3 is a perspective view illustrating the autonomously traveling device according to the present embodiment.

As illustrated in FIG. 1, an autonomously traveling vehicle 1 according to the present embodiment is a carriage type vehicle including a flat-plate-like main body portion 10 and a handle 11 to be gripped by a person. Two wheels 12, 12 are attached to a front side of a lower surface of the main body portion 10, and the wheels 12 are rotatably configured.

As illustrated in FIGS. 1 to 3, an autonomously traveling device 20 is provided at a back side of a lower surface of the main body portion 10, and the autonomously traveling device 20 is attached to the main body portion 10 so as to be swingable in a front-back direction. The autonomously traveling device 20 includes a horizontally-long casing 21 that extends in a width direction of the main body portion 10. Two drive wheels 22, 22 are respectively attached to both sides of the lower surface of the casing 21 in such a manner that the drive wheels can be rotationally driven. Further, assist wheels 23 are provided at a front portion and a back portion of the casing 21.

As illustrated in FIGS. 2 and 3, a distance sensor 24, which is composed of, for example, an optical sensor, and a camera 25, which captures an image of a person P located at the back side of the casing 21, are mounted on the back side of the casing 21.

The distance sensor 24 is configured to detect a distance from the person P who uses the autonomously traveling vehicle 1. The camera 25 captures an image of the person P to capture an image of a behavior of the person P, such as a motion of the face of the person P, a motion of a line of sight of the person P, or a motion of the feet of the person.

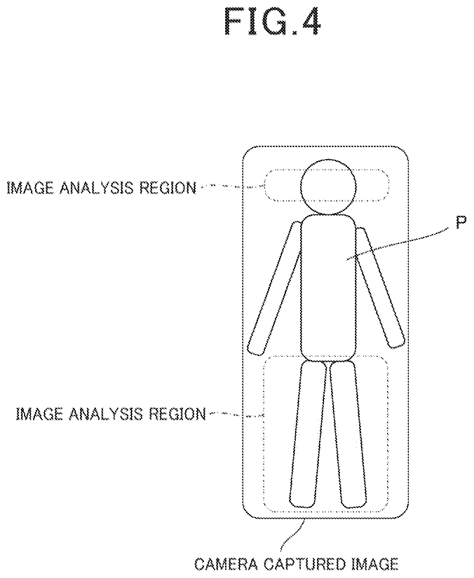

FIG. 4 is an explanatory view illustrating an example of a state where an image of the person P is captured by the camera 25.

As illustrated in FIG. 4, the camera 25 captures an image of the entire body of the person P. This enables the camera 25 to capture an image of a behavior, such as a motion of the feet, the orientation of the face, the line of sight, or the orientation of the body of the person P. Further, the position of the person P can also be detected within a photographing range of the camera 25 from the captured image.

In the present embodiment, the distance sensor 24 and the camera 25 constitute a person detection sensor described herein.

Further, the casing 21 is provided with a gyroscope sensor 26. The gyroscope sensor 26 is an angular velocity sensor and can detect a vibration or impact applied to the autonomously traveling device 20, or a posture of the autonomously traveling device 20.

An objective sensor 27 is provided at the front side of the casing 21. The objective sensor 27 is composed of, for example, a doppler sensor, and detects the presence or absence of an obstacle in front of the traveling direction of the autonomously traveling vehicle 1, a distance from an obstacle, and the like. When a doppler sensor is used as the objective sensor 27, an object located at a constant distance from the doppler sensor cannot be recognized as an obstacle. Accordingly, the objective sensor is excellent in that there is no need perform processing that is unnecessary for obstacle recognition processing. In the present embodiment, the wheels 12 located at the front side of the objective sensor 27 are not recognized as an obstacle.

Note that, for example, the distance sensor 24 may be used as the objective sensor 27. In this case, since the wheels 12 can be recognized as an obstacle as described above, there is a need to perform processing to prevent the wheels 12 from being recognized as an obstacle in consideration of the distance from the wheels 12.

Further, the presence or absence of an obstacle and the distance from an obstacle may be recognized by using a camera as the objective sensor 27 and by performing an image analysis of image capturing information obtained by the camera.

Next, a control configuration according to the present embodiment will be described.

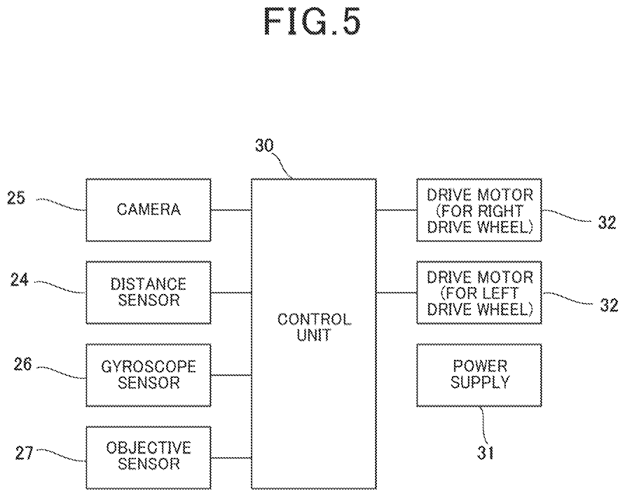

FIG. 5 is a block diagram illustrating a control configuration according to the present embodiment.

As illustrated in FIG. 5, in the present embodiment, the autonomously traveling device 20 includes a control unit 30 which is composed of, for example, a CPU and a memory, and is operated based on a predetermined program.

The control unit 30 is configured to receive detected signals from the distance sensor 24, the gyroscope sensor 26, and the objective sensor 27.

The control unit 30 recognizes the distance from the person P located behind the autonomously traveling vehicle 1 based on the detected signal from the distance sensor 24. Further, the control unit 30 recognizes the posture or vibration of the autonomously traveling device 20 based on the detected signal from the gyroscope sensor 26. The control unit 30 recognizes the presence or absence of an obstacle located in front of the autonomously traveling vehicle 1 and the distance from the obstacle based on the detected signal from the objective sensor 27.

Further, the control unit 30 is configured to receive the image capturing information obtained by the camera 25. The control unit 30 is configured to perform an image analysis based on the image capturing information obtained by the camera 25, thereby obtaining behavior information about the person P, such as a motion of the feet of the person P, the orientation of the face of the person P, and the line of sight of the person P. Various analysis means are used for the image analysis. For example, it is preferable to use an image recognition technique using AI.

Then, an image of the person P is captured by the camera 25, and the control unit 30 performs an image analysis based on the image capturing information. In this case, in an example illustrated in FIG. 4, when the foot portion of the person P is set as an image recognition region as indicated by a dashed-dotted line in the figure, a motion of the feet of the person P can be recognized. Further, when the eye portion of the person P is set as an image recognition region, a motion of the line of sight of the person P can be recognized.

Note that in the present embodiment, the distance from the person P is detected by the distance sensor 24. However, for example, the distance from the person P may be detected based on the image capturing information obtained by the camera 25.

A power supply 31 for supplying power to each of the control unit 30, the distance sensor 24, the gyroscope sensor 26, the objective sensor 27, and the camera 25 is provided. A battery, a chargeable secondary battery, or the like is used as the power supply 31.

The control unit 30 controls driving of two drive motors 32 for driving the two drive wheels 22, respectively. The control unit 30 controls driving of the drive motors 32 based on the detected signals from the distance sensor 24, the gyroscope sensor 26, and the objective sensor 27 and the image capturing information obtained by the camera 25.

Specifically, first, in a state where the power supply 31 of the autonomously traveling device 20 is turned off, the autonomously traveling device 20 is in a standby state where the posture is not controlled and the assist wheels 23 are in contact with the ground.

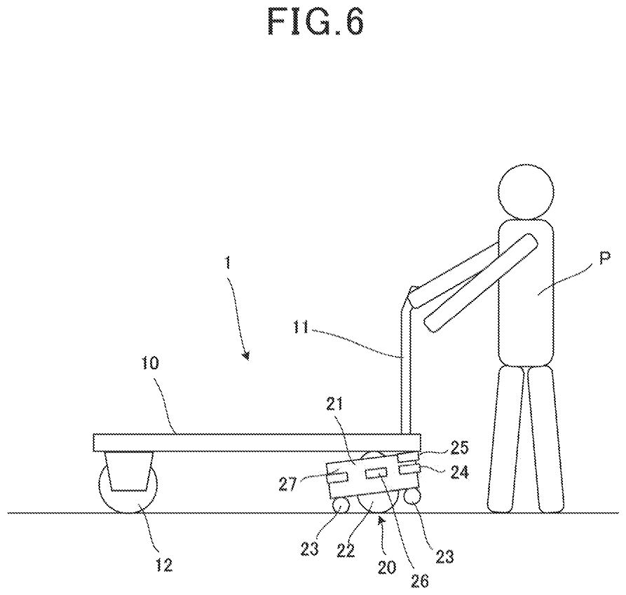

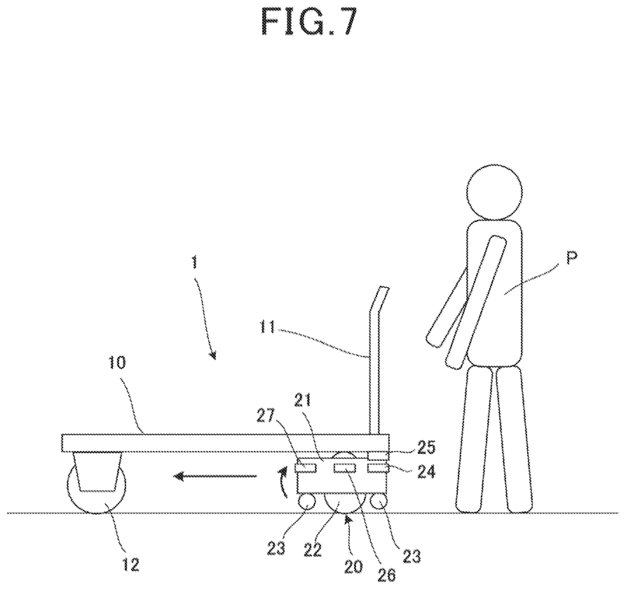

FIG. 6 is a schematic view illustrating the standby state of the autonomously traveling vehicle 1. FIG. 7 is a schematic view illustrating a traveling start state of the autonomously traveling vehicle.

When a vibration or impact is applied by the person P, for example, by tapping the handle 11 or pushing the handle 11, from the standby state illustrated in FIG. 6, the gyroscope sensor 26 detects the vibration or impact and the power supply 31 is turned on.

The control unit 30 drives the drive motors 32 based on the detected signal from the gyroscope sensor 26, thereby holding the autonomously traveling vehicle 1 in a horizontal state as illustrated in FIG. 7.

In this state, the control unit 30 constantly obtains the detected signals from the distance sensor 24, the gyroscope sensor 26, and the objective sensor 27, and also obtains the image capturing information obtained by the camera 25.

Then, when the person P pushes the handle 11, the casing 21 is inclined with respect to the main body portion 10, the gyroscope sensor 26 detects that the handle 11 is pushed. Thus, the control unit 30 drives the drive motors 32 and controls driving of the drive motors 32 so as to travel straight ahead in a direction in which the handle 11 is pushed.

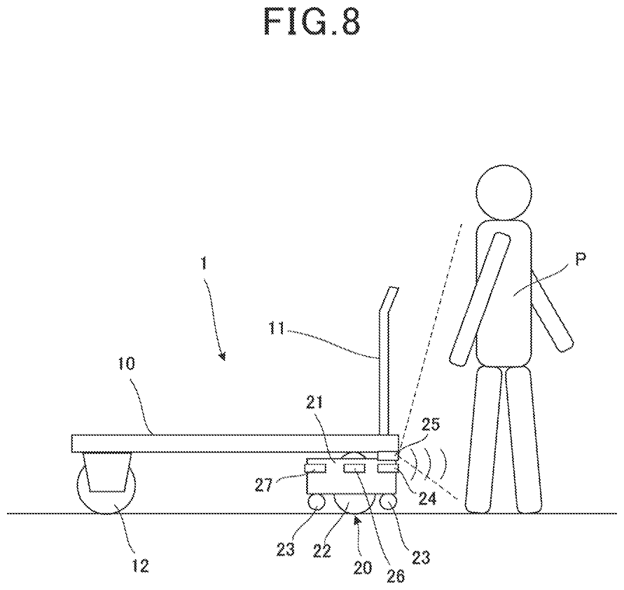

FIG. 8 is a schematic view illustrating an autonomously traveling state of the autonomously traveling vehicle 1.

As illustrated in FIG. 8, in the autonomously traveling state, even after the person P loses the grip of the handle 11, the autonomously traveling state is maintained.

Then, in a case where the distance from the person P is detected by the distance sensor 24 in a state where the drive motors 32 are driven to travel straight ahead and the distance from the person P is more than or equal to a predetermined distance, the driving speed of the drive motors 32 is reduced to thereby reduce the traveling speed, or the drive motors 32 are stopped to thereby stop the autonomously traveling vehicle 1.

Thus, the autonomously traveling vehicle 1 can autonomously travel while holding a predetermined distance in front of an operator.

Further, when the control unit 30 monitors the behavior of the person P based on the image capturing information obtained by the camera 25 and a turning behavior is indicated by the person P, the control unit 30 adjusts the number of rotations of the drive motors 32 and controls the autonomously traveling vehicle 1 to turn in the direction in which the turning behavior is indicated by the person P by causing the drive wheels 22 to be rotated differently. The turning behavior of the person P described herein refers to such a behavior that, for example, the orientation of the body of the person P has changed, the orientation of the face of the person P has changed, or the line of sight of the person P has changed.

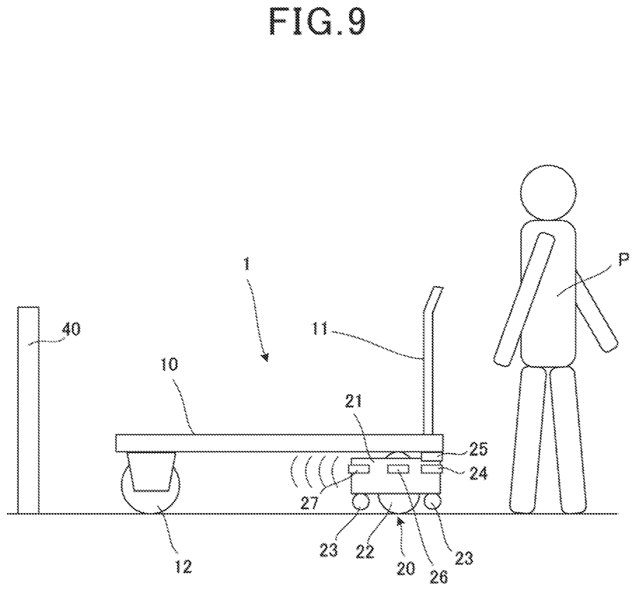

FIG. 9 is a schematic view illustrating a state where an obstacle is located in front of the autonomously traveling vehicle 1.

As illustrated in FIG. 9, when an obstacle 40 is detected in front of the autonomously traveling vehicle 1 by the objective sensor 27, the control unit 30 controls the drive motors 32 to control the rotation of the drive wheels 22 so as to cause the autonomously traveling vehicle 1 to turn, thereby controlling the autonomously traveling vehicle to avoid the obstacle 40. In this case, if the control unit 30 detects the obstacle 40 even after the obstacle 40 is avoided and it is determined that the obstacle 40 is not avoided, the drive motors 32 are stopped to thereby stop the autonomously traveling vehicle 1.

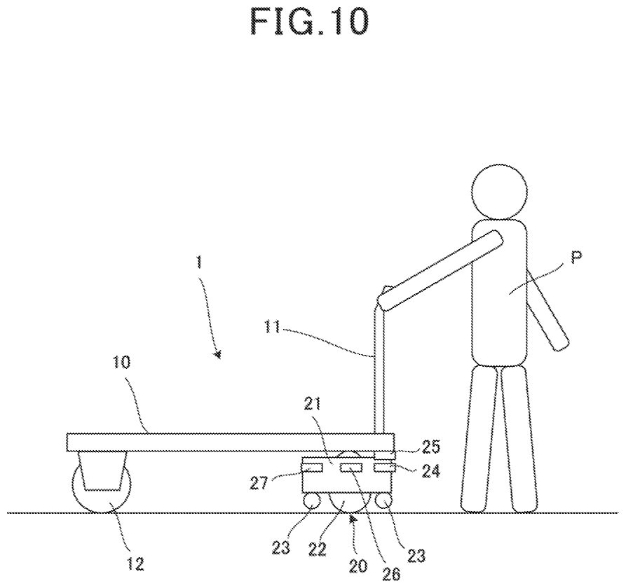

FIG. 10 is a schematic view illustrating a state where the autonomously traveling vehicle 1 is stopped.

As illustrated in FIG. 10, when the person P performs an operation to apply a vibration to the handle 11 by, for example, tapping the handle 11 or pulling the handle 11, the gyroscope sensor 26 detects the vibration. Upon detection of the vibration, the control unit 30 controls the autonomously traveling vehicle 1 to stop by stopping the drive motors 32.

In this state, when the person P applies a vibration to the handle 11, the gyroscope sensor 26 detects the vibration, and upon detection of the vibration, the control unit 30 turns off the power supply 31.

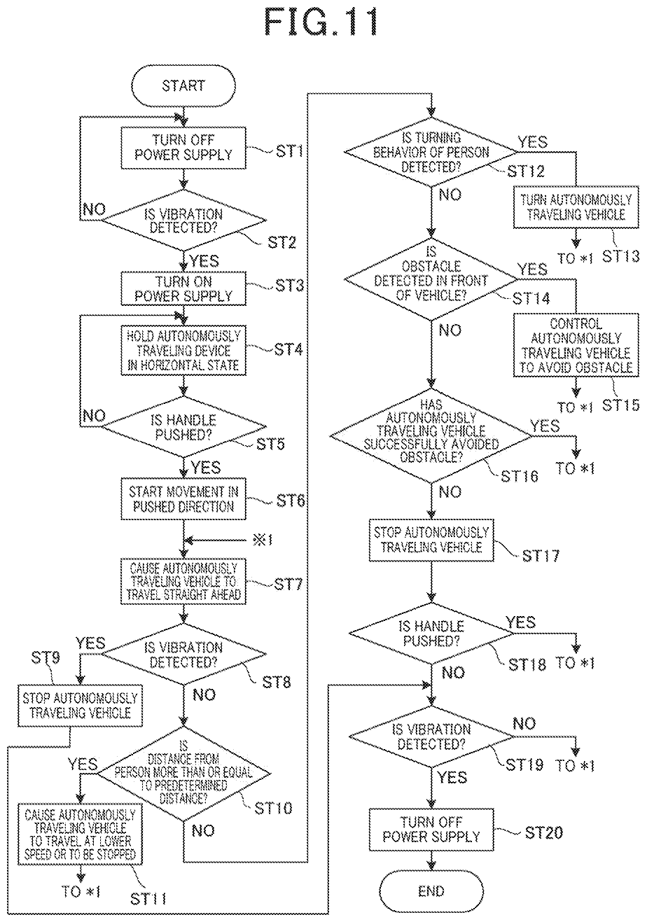

Next, an operation according to the present embodiment will be described with reference to a flowchart illustrated in FIG. 11.

First, from the standby state where the power supply 31 of the autonomously traveling device 20 is turned off (ST1), the person P applies a vibration to the handle 11, and when the gyroscope sensor 26 detects the vibration (ST2: YES), the power supply 31 is turned on (ST3).

The control unit 30 drives the drive motors 32 based on the detected signal from the gyroscope sensor 26, and holds the autonomously traveling vehicle 1 in the horizontal state (ST4).

In this state, the control unit 30 constantly obtains the detected signals from the distance sensor 24, the gyroscope sensor 26, and the objective sensor 27, and also obtains the image capturing information obtained by the camera 25.

Then, when the gyroscope sensor 26 detects that the handle 11 is pushed by the person P (ST5: YES), the control unit 30 controls driving of the drive motors 32 to drive the drive motors 32 to travel straight ahead in the direction in which the handle 11 is pushed (ST6).

In the state where the autonomously traveling vehicle 1 travels straight ahead by autonomously traveling (ST7), when the autonomously traveling vehicle 1 is to be stopped, the person P applies a vibration by tapping the handle 11. When this vibration is detected by the gyroscope sensor 26 (ST8: YES), the control unit 30 stops the drive motors 32 to thereby stop the autonomously traveling vehicle 1 (ST9).

Then, when the gyroscope sensor 26 detects that a vibration is applied to the handle 11 by the person P (ST19: YES), the control unit 30 turns off the power supply 31 (ST20).

On the other hand, in the state where the autonomously traveling vehicle is traveling straight ahead by autonomously traveling (ST7), when the distance from the person P is detected by the distance sensor 24 and it is determined that the distance from the person P is more than or equal to the predetermined distance (ST10: YES), the control unit 30 reduces the traveling speed by reducing the driving speed of the drive motors 32, or stops the autonomously traveling vehicle 1 by stopping the drive motors 32 (ST11).

Thus, the autonomously traveling vehicle 1 can autonomously travel while holding a predetermined distance in front of the person P.

After that, the control unit 30 causes the autonomously traveling vehicle 1 to travel straight ahead (ST7), and then determines the distance from the person P again (ST10). Then, when it is determined that the distance from the person P is not more than or equal to the predetermined distance (ST10: NO), the control unit causes the autonomously traveling vehicle 1 to continuously travel straight ahead.

Further, if it is determined that the distance from the person P is not more than or equal to the predetermined distance (ST10: NO), the control unit 30 monitors the behavior of the person P based on the image capturing information obtained by the camera 25, and when the control unit 30 determines that the turning behavior is indicated by the person P (ST12: NO), the control unit 30 controls the autonomously traveling vehicle 1 to turn in the direction in which the turning behavior is indicated by the person P (ST13). The control unit 30 causes the autonomously traveling vehicle 1 to turn by a required amount, and then causes the autonomously traveling vehicle 1 to travel straight ahead (ST7).

If the control unit 30 determines that the turning behavior of the person P is not detected (ST12: NO), the control unit 30 determines whether the obstacle 40 is present in front of the autonomously traveling vehicle 1 based on the objective sensor 27 (ST14).

Then, when the objective sensor 27 detects the obstacle 40 in front of the autonomously traveling vehicle 1 (ST14: YES), the control unit 30 controls the drive motors 32 to control the rotation of the drive wheels 22, thereby controlling the autonomously traveling vehicle 1 to avoid the obstacle 40 (ST15). The control unit 30 controls the autonomously traveling vehicle 1 to avoid the obstacle and then causes the autonomously traveling vehicle 1 to travel straight ahead (ST7).

In this case, the control unit 30 determines whether the obstacle 40 is avoided after the autonomously traveling vehicle is controlled to avoid the obstacle 40 (ST16). If it is determined that the obstacle 40 is avoided (ST16: YES), the autonomously traveling vehicle 1 is caused to travel straight ahead (ST7).

On the other hand, if it is determined that the obstacle 40 is not avoided (ST16: NO), the drive motors 32 are stopped to thereby stop the autonomously traveling vehicle 1 (ST17).

After that, when it is determined that there is no problem with the person P and the autonomously traveling vehicle 1 is allowed to travel, the person P pushes the handle 11 (ST18: YES), and the control unit 30 causes the autonomously traveling vehicle 1 to travel straight ahead (ST7).

On the other hand, when the person P does not push the handle 11 (ST18: NO) and when the gyroscope sensor 26 detects that the person P applies a vibration to the handle 11 (ST19: YES), the control unit 30 turns off the power supply 31 (ST20).

Then, in the state where the autonomously traveling vehicle 1 is traveling straight ahead, the control unit 30 repeatedly performs the processes from steps (ST7) to (ST19) described above, thereby enabling the autonomously traveling vehicle 1 to autonomously travel.

As described above, in the present embodiment, the autonomously traveling device 20 that travels in front of the person P is provided. The autonomously traveling device 20 includes the distance sensor 24 and the camera 25 (person detection sensor) which detect at least the behavior of the person P and the distance from the person P, and the control unit 30 controls the autonomously traveling device 20 based on the detected information from the distance sensor 24 and the camera 25.

With this configuration, the autonomously traveling vehicle 1 can autonomously travel in front of the person P. Accordingly, it is possible to constantly monitor baggage placed on the autonomously traveling vehicle 1, thereby enhancing crime prevention. Further, since the person P monitors the autonomously traveling vehicle 1, a stopped state or the like of the autonomously traveling vehicle 1 can be easily checked, which leads to an enhancement of reliability.

Further, in the present embodiment, the camera 25 (person detection sensor) detects the behavior of the person P, and the control unit 30 controls the autonomously traveling device 20 to turn in a direction in which the person P detected by the camera 25 faces.

Thus, the control unit 30 controls the autonomously traveling device 20 to turn in the direction in which the person P detected by the camera 25 faces, thereby enabling the autonomously traveling vehicle 1 to automatically turn depending on the behavior of the person P.

Further, in the present embodiment, the autonomously traveling device 20 includes the gyroscope sensor 26. The gyroscope sensor 26 detects a vibration that is applied to the autonomously traveling device 20 by the person P, and when the gyroscope sensor 26 detects the vibration, the control unit 30 controls the autonomously traveling device 20 to be started.

With this configuration, the control unit 30 controls the autonomously traveling device 20 to be started when the gyroscope sensor 26 detects the vibration. Therefore, the autonomously traveling vehicle 1 can be easily started only by the operation in which the person P applies a vibration.

Further, in the present embodiment, when the control unit 30 determines that the distance from the person P detected by the distance sensor 24 (person detection sensor) is more than or equal to the predetermined distance, the control unit 30 controls the autonomously traveling device 20 to travel at a lower speed, or to stop.

Thus, when the distance from the person P detected by the distance sensor 24 is more than or equal to the predetermined distance, the autonomously traveling device 20 is controlled to travel at a lower speed, or to stop, thereby enabling the autonomously traveling device 20 to autonomously travel in front of the person P while preventing the autonomously traveling vehicle 1 from being apart from the person P.

Further, in the present embodiment, the autonomously traveling device 20 includes the objective sensor 27. When the objective sensor 27 detects the obstacle 40 in front of the autonomously traveling device 20, the control unit 30 controls the autonomously traveling device 20 to avoid the obstacle 40, or to stop.

With this configuration, when the objective sensor 27 detects the obstacle 40 in front of the autonomously traveling device 20, the control unit 30 controls the autonomously traveling device 20 to avoid the obstacle 40, or to stop, thereby preventing the autonomously traveling vehicle 1 from colliding with the obstacle 40.

Note that the present invention is not limited to the embodiments and can be modified in various ways within the scope of the invention described in the claims. These modifications are also included in the scope of the present invention, needless to say.

For example, while the embodiments illustrate a case where a carriage type vehicle is used as the autonomously traveling vehicle 1, the present invention is not limited to this case. Any vehicle may be used as long as the autonomously traveling device 20 can be attached to the vehicle.

### REFERENCE SIGNS LIST

1 autonomously traveling vehicle
10 main body portion
11 handle
12 wheel
20 autonomously traveling device
21 casing
22 drive wheel
23 assist wheel
24 distance sensor
25 camera
26 gyroscope sensor
27 objective sensor
30 control unit
31 power supply
32 drive motor
40 obstacle
P person

1. An autonomously traveling vehicle comprising:
an autonomously traveling device that travels in front of a person,
wherein the autonomously traveling device includes:
a person detection sensor that detects at least a behavior of person and a distance from a person; and
a control unit that controls the autonomously traveling device based on detected information from the person detection sensor.

2. The autonomously traveling vehicle according to claim 1,
wherein the person detection sensor detects the behavior of the person, and
wherein the control unit controls the autonomously traveling device to turn in a direction in which the person detected by the person detection sensor faces.

3. The autonomously traveling vehicle according to claim 1,
wherein the autonomously traveling device includes a gyroscope sensor and the gyroscope sensor detects a vibration applied to the autonomously traveling device by the person, and
wherein in a case where a vibration is detected by the gyroscope sensor, the control unit controls the autonomously traveling device to be started.

4. The autonomously traveling vehicle according to claim 1, wherein in a case where the control unit determines that the distance from the person detected by the person detection sensor is more than or equal to a predetermined distance, the control unit controls the autonomously traveling device to travel at a lower speed, or to stop.

5. The autonomously traveling vehicle according to claim 1,
wherein the autonomously traveling device includes an objective sensor, and
wherein in a case where an obstacle is detected in front of the autonomously traveling device by the objective sensor, the control unit controls the autonomously traveling device to avoid the obstacle, or to stop.

6. An autonomously traveling device to be attached to an autonomously traveling vehicle, the autonomously traveling device comprising:
a drive wheel for traveling in front of a person;
a person detection, sensor that detects at least a behavior of a person and a distance from a person; and
a control unit that controls driving of the drive wheel based on detected information from the person detection sensor.

7. The autonomously traveling vehicle according to claim 2,
wherein the autonomously traveling device includes a gyroscope sensor and the gyroscope sensor detects a vibration applied to the autonomously traveling device by the person, and
wherein in a case where a vibration is detected by the gyroscope sensor, the control unit controls the autonomously traveling device to be started.

8. The autonomously traveling vehicle according to claim 2, wherein in a case where the control unit determines that the distance from the person detected by the person detection sensor is more than or equal to a predetermined distance, the control unit controls the autonomously traveling device to travel at a lower speed, or to stop.

9. The autonomously traveling vehicle according to claim 3, wherein in a case where the control unit determines that the distance from the person detected by the person detection sensor is more than or equal to a predetermined distance, the control unit controls the autonomously traveling device to travel at a lower speed, or to stop.

10. The autonomously traveling vehicle according to claim 2,
wherein the autonomously traveling device includes an objective sensor, and
wherein in a case where an obstacle is detected in front of the autonomously traveling device by the objective sensor, the control unit controls the autonomously traveling device to avoid the obstacle, or to stop.

11. The autonomously traveling vehicle according to claim 3,
wherein the autonomously traveling device includes an objective sensor, and
wherein in a case where an obstacle is detected in front of the autonomously traveling device by the objective sensor, the control unit controls the autonomously traveling device to avoid the obstacle, or to stop.

12. The autonomously traveling vehicle according to claim 4,
wherein the autonomously traveling device includes an objective sensor, and
wherein in a case where an obstacle is detected in front of the autonomously traveling device by the objective sensor, the control unit controls the autonomously traveling device to avoid the obstacle, or to stop.
